(19) United States
(12) Patent Application Publication
(10) Pub. No.: US 2006/0266297 A1
(43) Pub. Date: Nov. 30, 2006

(54) System for grading marine animals by size

(76) Inventor: Ian McRobert, Wungong (AU)

Correspondence Address: JACQUELINE E. HARTT, PH.D;ALLEN, DYER, DOPPELT, MILBRATH & GILCHRIST, P.A., P.O. BOX 3791, ORLANDO, FL, 32802-3791, US

(21) Appl. No.: 10/557,716

(22) PCT Filed: May 9, 2003
(86) PCT No.: PCT/AU03/00555

§ 371 Date: Jul. 31, 2006

(30) Foreign Application Priority Data
May 10, 2002 (AU) PS 2251

(51) Int. Cl. A01K 63/00

(52) U.S. Cl. 119/216

(57) ABSTRACT

A grading system (10) for grading marine animals such as fish (12) by size includes a receptacle (14) for holding a volume of water (16) and the fish (12). The receptacle (14) includes a landing (18) through which fish can enter and exit the receptacle (14). A grader (20) is supported to rotate through the water (16) about a horizontal axle (22). The grader (20) includes a first panel (24a) which is provided with a plurality of openings (26a) in the form of gaps between parallel radially extending rods (28). The panel (24a) has an outer peripheral edge (30) constituted by two radial edges (32a) and a lateral outer edge (34a) extending between the radial edges (32a). The outer peripheral edge (30) contacts or is sufficiently close to an inside surface (36) of the receptacle (14) to prevent the passage of fish (12) between the edge (30) and an inside surface (36) of the receptacle (14). As grader (20) is rotated in a clockwise direction (D) about the axle (22) to a first grading position where the lateral edge (34a) is adjacent the landing (18), the panel (24a) sweeps through the receptacle. The fish which are sufficiently small are able to pass through the openings (26a) leaving the larger fish in front of the panel (24a). When the grader (20) reaches the first position, the only fish (12) in advance of the panel (24a) are those which are too big to pass through the openings (26a). These are now directed through the landing (18) out of the receptacle (14).

### FIELD OF THE INVENTION

The present invention is for a system for grading marine animals by size.

### BACKGROUND OF THE INVENTION

Most commonly, the grading of marine animals in commercial land based agricultural farms is performed manually. This requires a harvester to enter an aquaculture tank, scoop the marine animals with a net and drop them onto a grading sieve. The sieve is provided with a number of holes through which animals of a smaller size can pass. The remaining animals are trapped on the sieve and can be transferred to other locations for processing as required.

This method of grading is very inefficient as it consumes substantial manpower and time. Also, it is often difficult to catch all the marine animals within a tank for grading. It is also known that subjecting marine animals to this form of grading is particularly stressful for the marine animals and can lead to death or adversely affect their feeding habits for a period of time after grading thereby reducing their growth rate.

Present applicant has devised a grading system described in International Application No. PCT/AU00/01250 which includes a plurality of stacked platforms each having holes of different size where the platforms can be rotated and or lifted about a vertical axis to facilitate separation of the marine animals on the basis of their size.

The present invention is a further development on the applicant's previous grading system.

### SUMMARY OF THE INVENTION

According to the present invention there is provided a system for grading marine animals by size said system including at least:

a receptacle for holding a volume of water and a plurality of marine animals, said receptacle having an inside surface and a landing through which marine animals can enter and exit said receptacle; and

grading means supported to rotate about a horizontal axis through said volume of water, said grading means including a first panel provided with a plurality of openings through which first marine animals of a first size can not pass, said first panel having an outer peripheral edge which contacts or is sufficiently close to said inside surface of said receptacle to prevent marine animals from passing between said outer peripheral edge and said inside surface, said grading means having a first grading position where said grading means is rotated to a position where said first fish can be discharged through said landing;

whereby, in use, as said grading means rotates about said axis to said first grading position, said first panel sweeps through said receptacle allowing marine animals other than said first marine animals to pass through said first panel to separate said first marine animals from said plurality of marine animals, wherein when said grading means is in said first grading position, said first marine animals can be directed through said landing and out of said receptacle.

Preferably said grading means includes one or more further panels, each further panel extending radially from said axis of rotation, said first panel leading said further panels in relation to the direction of rotation of said grading means, said further panels provided with respective openings where the openings in successive further panels in a direction counter to the direction of rotation starting from said first panel are of progressively smaller size, each of said further panels having a respective outer peripheral edge which contacts or is sufficiently close to said inside surface of said receptacle to prevent marine animals from passing between said respective outer peripheral edges and said inside wall, and said grading means having a plurality of further grading positions corresponding to rotational locations of said grading means where marine animals of progressively reducing size range can be directed through said landing and out of said receptacle.

Preferably said receptacle is supported on a carriage providing the system with at least a degree of motion.

Preferably said carriage is arranged to facilitate linear and/or rotational motion of said receptacle.

Preferably each panel is demountably coupled at an axial inner edge to said grading means to allow said panels to be tilted or lifted about a corresponding axial outer edge when in this corresponding grading position to further direct marine animals to pass through said landing.

Preferably said system includes a vessel for holding a further volume of water and in which said receptacle is disposed, and wherein said receptacle is in fluid communication with said vessel whereby water can flow between said vessel and receptacle without a transfer of the marine animals.

In one embodiment, said grading means rotates relative to said receptacle. In this embodiment, said receptacle is provided with a single landing and a set of grading positions are characterised by a length of the outer peripheral edge of said panels being rotated to a location adjacent said landing.

However, in an alternate embodiment, said grading means and receptacle rotate together. In this embodiment, the receptacle is provided with a plurality of landings, one for each panel of said grading means where the landing is adjacent a length of the outer peripheral edge of each panel, with the receptacle further including a plurality of gates for selectively opening and closing said landing.

### BRIEF DESCRIPTION OF THE DRAWINGS

Embodiments of the present invention will now be described by way of example only with reference to the accompanying drawings in which:

FIG. 1 is a schematic representation of a first embodiment of the system for grading marine animals;

FIG. 2 is an end elevation of the system depicted in use in an aquaculture system;

FIG. 3 is a side view of a further embodiment of the system for grading marine animals;

FIG. 4 is a more detailed partial view of the system depicted in FIG. 3 prior to the transfer of fish from the grading system to an aquaculture system;

FIG. 5 is a view of the system depicted in FIG. 4 during a transfer of fish from the grading system to the aquaculture system;

FIG. 6 depicts a further embodiment of the system for grading fish;

FIG. 7 is a schematic representation depicting a method of use of the system shown in FIG. 6;

FIG. 8 is a schematic representation of an aquaculture system incorporating the grading system shown in FIGS. 6 and 7; and

FIG. 9 is a schematic representation of a further embodiment of the system.

### DETAILED DESCRIPTION OF PREFERRED EMBODIMENT

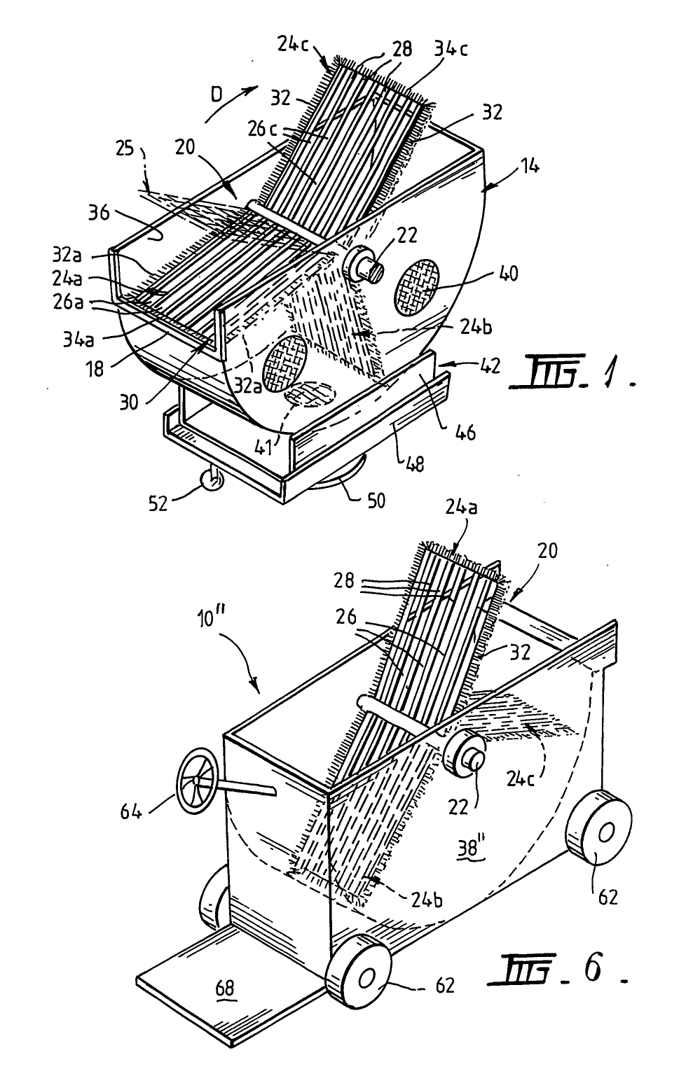

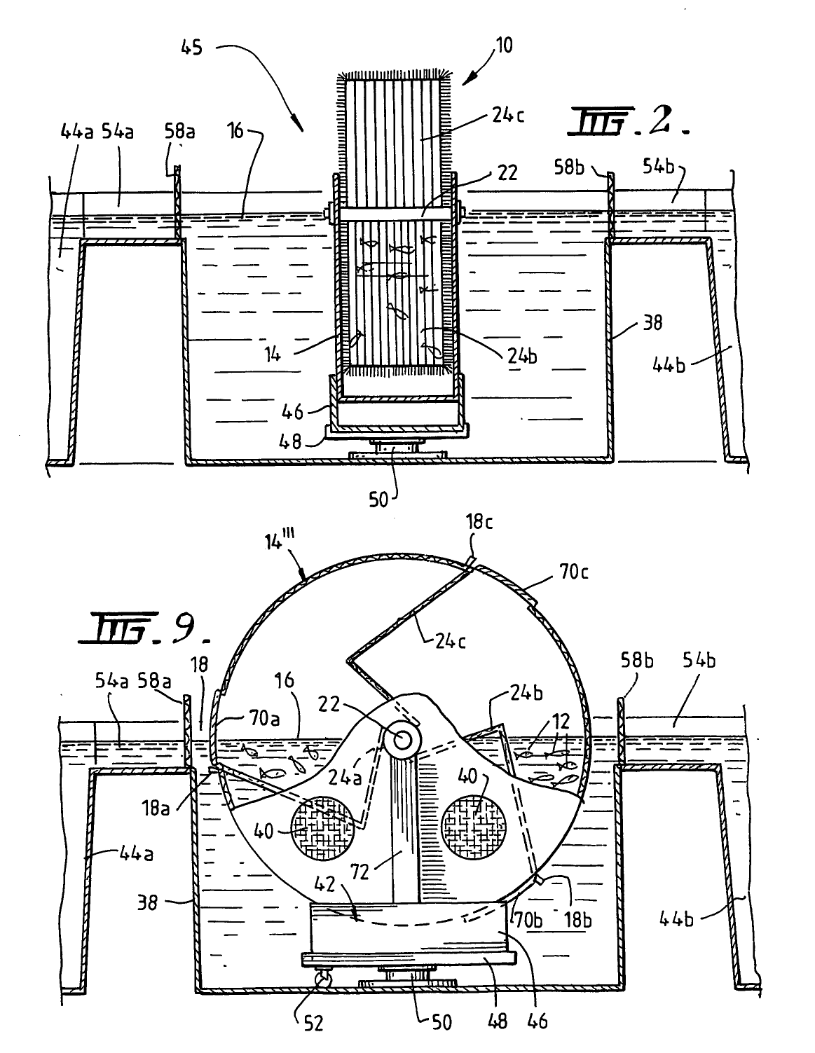

Referring to the accompanying drawings and in particular, FIGS. 1 and 2, an embodiment of the system 10 for grading marine animals such as fish 12 by size includes a receptacle 14 for holding a volume of water 16 and the fish 12. The receptacle 14 includes a landing (or opening) 18 through which the fish can enter and exit the receptacle 14. A grading means (or grader) 20 is supported to rotate through the water 16 about a horizontal axis constituted by axle 22. The grader 20 includes a first panel 24a which is provided with a plurality of openings 26a, in the form of gaps between parallel radially extending rods 28 through which a first group of fish of a first size can not pass. The panel 24a has an outer peripheral edge 30 constituted by two radial edges 32a and a lateral or axial outer edge 34a extending between the radial edges 32a. The outer peripheral edge 30 contacts or is sufficiently close to an inside surface 36 of the receptacle 14 to prevent the passage of fish 12 between the outer peripheral edge 30 and the inside surface 36.

The grader 20 also has a first grading position where the grader 20 is rotated to a position where the lateral edge 34a (being a length of the peripheral edge 30) is adjacent the landing 18. This is depicted in FIG. 1.

As the grader 20 is rotated in a clockwise direction D about the axle 22 to the first grading position where the lateral edge 34a of panel 24a is adjacent the landing 18, the panel 24a sweeps through the receptacle. Fish which are sufficiently small are able to pass through the openings 26a of the panel 24a leaving the larger fish in front of the panel 24a. When the grader 20 reaches the first position, in substance, the only fish 12 in advance of the panel 24a are those which are too big to pass through the openings 26a. These are now directed through the landing 18 out of the receptacle 14. As explained in greater detail below, these fish can be transferred to another aquaculture tank.

In addition to the first panel 24a, the grader 20 depicted in FIGS. 1 and 2 is provided with two further panels 24b and 24c. The panels 24a, 24b and 24c (hereinafter referred to in general as “panels 24”) extend radially from the axle 22 and are evenly spaced about the axle 22. With the first panel 24a considered as the leading panel in terms of the direction of rotation D, panels 24b and 24c are provided with respective openings 26b and 26c which are of progressively smaller size. That is, panel 24a has the largest openings 26a, 24b has smaller openings 26b and panel 24c has the smallest openings 26c. Otherwise, the panels 24 are of identical construction having respective outer peripheral edges 32 which contact or are sufficiently close to the inside surface 36 to prevent the passage of fish 12 therebetween and which having respective lateral edges 34 that will lie substantially adjacent the landing 18 when the grader 20 is rotated into respective grading positions.

As the grader 20 rotates through the receptacle 14 the panels 24 sweep through the receptacle effectively separating the fish 12 into groups of different size which are sequentially presented to the landing 18. The largest fish are presented to the landing 18 when the grader 20 is rotated so that lateral edge 34a of panel 24a is adjacent the landing 18. A second group of fish of a size range small enough to pass through the openings 26a but too big to pass through the openings 26b are next presented to the landing 18 when the grader 20 is rotated so that the lateral edge 34b of panel 26b is adjacent the landing 18. As the grader 20 continues to rotate, a next group of fish of a size range sufficiently small to pass through the openings 26b but too large to pass through the openings 26c are presented to the landing 18a when the lateral edge 34c of panel 24c is adjacent the landing 18. A seal 27, such as a rubber strip can be placed over the surface of the mouth of the landing 18 to seal against transfer channels used for transferring fish between the receptacle 14 and a holding tank.

By the inclusion of an optional fine mesh screen (shown in phantom at 25 in FIG. 1) of a peripheral dimension identical to the panels 24 and located between the panels 24a and 24c, any remaining fish can be swept to the landing 18.

The rotation of grader 20 effectively creates a water current in a direction opposite the direction of rotation D. As fish tend to swim in a counter current direction this assists in directing the fish to swim through the openings 26 of the oppositely moving panel 24 to provide a degree of self grading. In addition an air injector 41 can be placed at the bottom of receptacle 14 to attract fish to swim theretowards. This induces fish in front of a panel 24 in its grading position to try to swim through the panel 24.

The receptacle 14 is supported on a carriage 42 providing it and the system 10 with a degree of mobility. The carriage 42 allows both linear and rotational motion of the receptacle 14. In this embodiment the linear motion is provided by mounting the receptacle 14 in a channel-like bracket or cradle 46, which in turn is slidably mounted in a track 48. The rotational motion, which is about a vertical axis, is provided by in turn mounting the track 48 on vertical axle or pedestal 50. A castor 52 is provided at an end of the track 48 to provide stability and support during the motion of the receptacle 14.

Referring to FIG. 2, the receptacle 14 may itself be disposed in a larger vessel 38. The vessel 38 holds a volume of water which is in communication with the water 16 in the receptacle 14 via the provision of screened holes 40 provided in the wall of the receptacle 14. The holes 40 allow water to flow between receptacle 14 and vessel 38 without allowing the passage of fish 12.

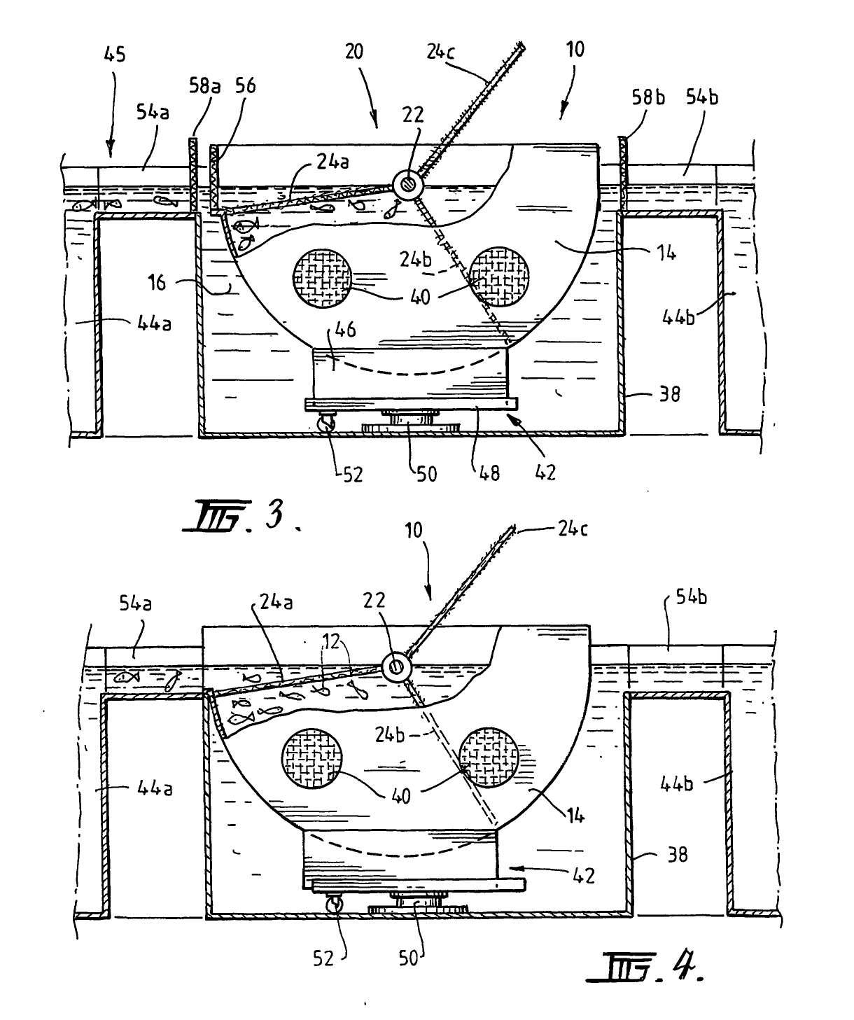

The operation of the grading system 10 will now be described with specific reference to FIGS. 2-4. FIGS. 2-4 depict a land based aquaculture system 45 which includes a plurality (in this particular instance two) aquaculture tanks 44a and 44b (referred to hereinafter in general as tanks 44), with the vessel 38 disposed therebetween. A transfer channel 54a is provided between the tank 44a and the vessel 38 with a further transfer channel 54b being provided between the aquaculture tank 44b and the vessel 38. The transfer channels allow water to flow between the receptacle 38 and the tanks 44a and 44b. A removable seal or gate 56 is placed over the landing 18 to prevent the fish 12 from passing through the landing 18 to the vessel 38. A gate 58a is also provided at an end of the transfer channel 54. Once the grader 20 has been rotated so as to separate a group of fish 12 on the basis of size from the remaining population of fish the receptacle 14 is slid along the carriage 42 by sliding the bracket 46 along track 48 so as to place the gates 56 and 58a adjacent to each other with the seal 27 abutting the transfer channel 44a. When the gates 56 and 58 are removed, the landing 18 is then in direct fluid communication with the transfer channel 54a, as shown in FIG. 4. The fish 12 are able to swim through the transfer channel 54a to the tank 44a. If it were desired to transfer the next size range of fish into tank 44b, the gate 56 and gate 58 of tank 44a would be reapplied to close the landing 18 and transfer channel 54a of tank 44a, and the grader 20 rotated through 120° so that the next panel 24b is rotated to a position where its lateral edge 34a is adjacent the landing 18. The receptacle 14 is then slid to the right to place the receptacle in a central position in the vessel 38 (as shown in FIG. 3) and then rotated on vertical axle 50 through 180° so that the landing 18 now faces the gate 58b of the transfer channel 54b of tank 44b. Receptacle 14 is then slid again on the carriage 42 further to the right so that the landing 18 is adjacent transfer channel 54b. The gates 56 and 58b are then opened allowing the transfer of fish through the channel 54b to the tank 44b.

FIG. 5 depicts a further embodiment of the grading system 10′ in which like reference numbers are used to denote like features described in relation to the first embodiment of the system 10, but with the addition of a ′ symbol. The substantive difference between the system 10′ in FIG. 5 and the first described embodiment is the shape of the panels 24′.

The panels 24′ are, in side view, of an L-shape and orientated so that the apex or corner of the L is disposed lower most in the receptacle 14 when the leading edge 34 is adjacent the landing 18. In this way, the panels 24′ together with the inside wall of the receptacle 14 form a small recess holding the fish 14 of a size too large to pass through the corresponding openings of the panel 24′. The panels 24′ are also demountably coupled at their axially (or lateral) innermost edge 60 so that they can be decoupled from the axle 22 and swung about their lateral edge 34 to assist in guiding the fish 12 through the transfer channel 54 to a corresponding tank 44. The decoupling and tilting of panel 24a is depicted in phantom in FIG. 5. In all other respects, system 10′ is the same as the system 10.

The aquaculture system 45′ in which the grading system 10′ is incorporated also differs from the aquaculture system depicted in FIGS. 2-4 in which the grading system 10 is used by the provision of invertible liners 70 in the tanks 44a and 44b. The liners 70 may be of a form, and operate in accordance with, that described in Applicant's International Application No's. PCT/AU97/00891 and PCT/AU00/00934, the contents of which are incorporated herein by way of reference. The use of the invertible liners 70 assists in transferring fish 12 between the tanks 44 and the grading system 10′.

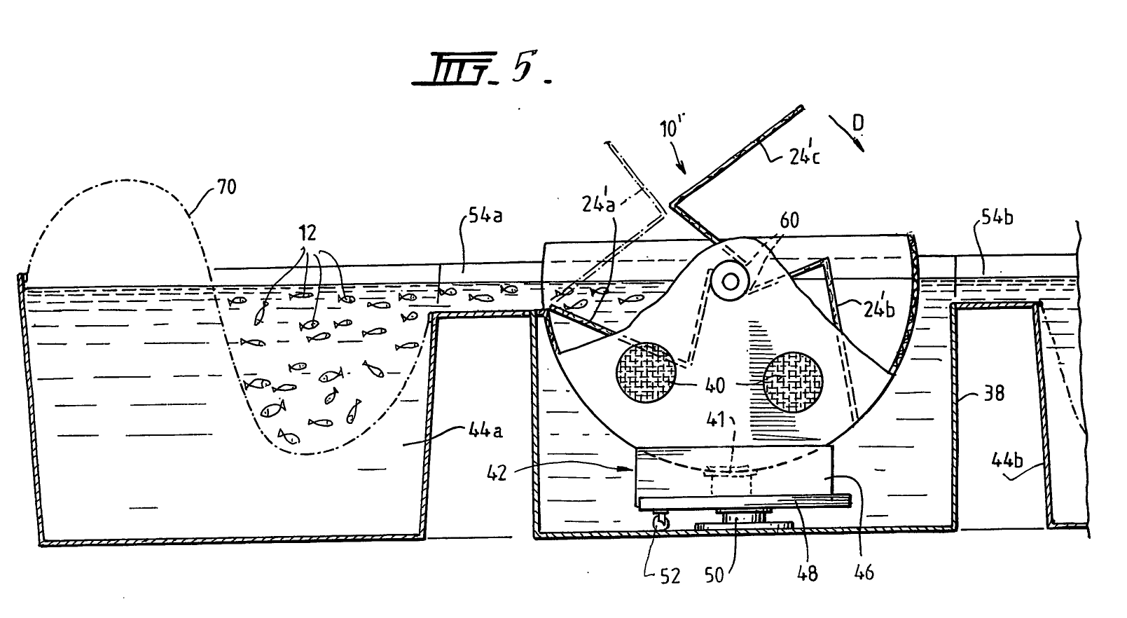

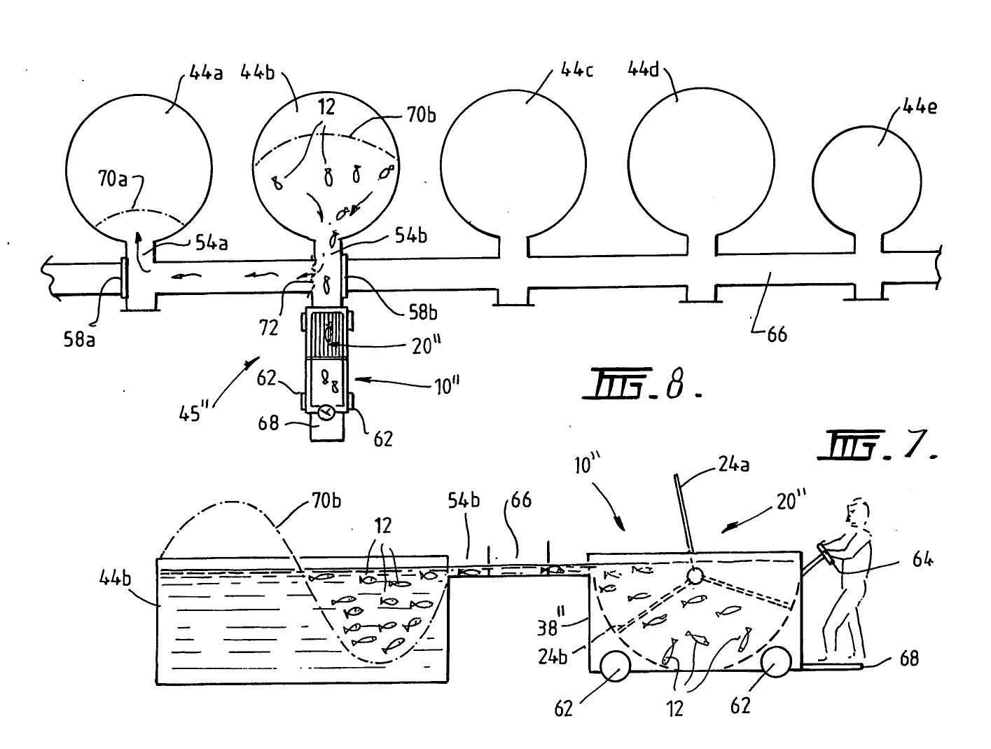

FIGS. 6-8 depict further an embodiment 10″ of the system used in an aquaculture system 45″. This embodiment differs from system 10 depicted in FIG. 1 in terms of the structure of the carriage 42″. In this embodiment, the carriage 42″ is constituted by the vessel 38″. Moreover, the vessel 38″ now constitutes a mobile tank provided with two pairs of wheels 62 with one of the pairs being steerable by a steering wheel 64. The vessel 38″ can be provided with a small motor (e.g. an electric motor—not shown) for driving or propelling the tank 38″ to various transfer channels 54 disposed along a common channel 66 linking transfer tanks 44a-44e of aquaculture system 45″ as depicted in FIG. 8. A small platform 68 is attached at one end of the vessel 38″ for an operator to stand on. Alternately, the vessel 38″ can be essentially in the form of a steerable trolley where an operator simply pushes and pulls the vessel 38″ to a desired location.

The tanks 44 in the aquaculture system depicted in FIG. 8 are preferably provided with invertible liners 70 and are of the type described in Applicant's International Applications PCT/AU00/00934 and PCT/AU97/00891. In FIG. 8, the liner 70b of tank 44b is being lifted forcing the water and fish to pass through transfer channel 54b to the common channel 66. The system 10″ is adjacent an opposite end of the transfer channel 54b and in fluid communication therewith. Gates 58b and 58a fluidly seal a portion of the common channel 66 between the transfer channels 54a and 54b. A mesh screen 72 is placed across the channel 66 on the side of the transfer channel 54b opposite the gate 58b. As the liner 70 is inverted, the majority of the water therefrom flows through the screen 72 channel 66 and transfer channel 58a into the tank 44a, lowering its liner 70a. A small volume of that water together with the fish 12 flow through the transfer channel 54b over the landing 18 and into the receptacle 14 of the system 10″. The system 10″ can then be moved to a transfer channel corresponding to another one of the tanks 44 and the grader 20 operated to grade the fish into one or more different size ranges. The system 10″ can then be parked adjacent the transfer channel of another tank 44 and operated so as to transfer a group of fish of a particular size into that particular tank.

A further embodiment of the system 10″′ is illustrated in FIG. 9. In this embodiment, the receptacle 14″′ is in the form of a cylindrical tank with its central axis disposed parallel to the axle 22. The circumferencial wall of the receptacle 14 is provided with three gates 70a, 70b and 70c which can be selectively opened or closed. The panels 24a-24c of the system 10″′ are of the same form as that depicted in FIG. 5 however in this embodiment, the panels 24 rotate with the receptacle 14″′. To facilitate this, both the grader 20, which includes the panels 24, and the receptacle 14″′ are supported by a bracket 72 extending from the carriage 42 to the axle 22.

It would be appreciated that as the receptacle 14″′ rotates about axle 22, the panels 24 rotate through the volume of water held within the receptacle 14″′ and therefore operate in the same manner as the previous embodiments in terms of separating fish 12 by size. However, whereas in the previous embodiments, a single landing 18 is provided to which each of the panels 24 is successively rotated, in the system of 10″′, the receptacle 14″′ includes three separate landings 18a-18c each of which is selectively opened and closed by respective gates 70a-70c.

Now that an embodiment of the present invention has been described in detail it will be apparent to those skilled in the relevant arts that numerous modifications and variations may be made without departing from the basic inventive concepts. For example, the grader 20 can be provided with any number of panels 24. Additionally, the panels can be made of various shapes other than the planer and L-shaped panels as depicted in the embodiments. Further, the panels can be removable to allow swapping with panels having openings of different size. Brushes or rubber seals can be disposed about the outer peripheral edge 30 of the panels 24 to prevent the passage of fish between the edge 30 and the inside surface of receptacle 14. The receptacles 14, 14″′ can be made from plastics materials, metals, or as a frame covered with a fine mesh of a size sufficiently small to prevent the passage of fish through the mesh. However, as explained here and above, if the receptacles are made from plastics material or metal meshed screens 40 as depicted in FIG. 1, are advantageously provided to allow fluid communication between the water within the receptacles 14 and the vessels 38 within which the receptacles are disposed. All such modifications and variations together with others that would be obvious to a person of ordinary skill in the art are deemed to be within the scope of the present invention, the nature of which is to be determined from the above description and the appended claims.

The claims defining the invention are as follows:

1. A system for grading marine animals by size said system including at least:
a receptacle for holding a volume of water and a plurality of marine animals, said receptacle having an inside surface and a landing through which marine animals can enter and exit said receptacle; and
grading means supported to rotate about a horizontal axis through said volume of water, said grading means including a first panel provided with a plurality of openings through which first marine animals of a first size can not pass, said first panel having an outer peripheral edge which contacts or is sufficiently close to said inside surface of said receptacle to prevent marine animals from passing between said outer peripheral edge and said inside surface, said grading means having a first grading position where said grading means is rotated to a position where said first fish can be discharged through said landing;
whereby, in use, as said grading means rotates about said axis to said first grading position, said first panel sweeps through said receptacle allowing marine animals other than said first marine animals to pass through said first panel to separate said first marine animals from said plurality of marine animals, wherein when said grading means is in said first grading position, said first marine animals can be directed through said landing and out of said receptacle.

2. The system according to claim 1 wherein said grading means includes one or more further panels, each further panel extending radially from said axis of rotation, said first panel leading said further panels in relation to the direction of rotation of said grading means, said further panels provided with respective openings where the openings in successive further panels in a direction counter to the direction of rotation starting from said first panel are of progressively smaller size, each of said further panels having a respective outer peripheral edge which contacts or is sufficiently close to said inside surface of said receptacle to prevent marine animals from passing between said respective outer peripheral edges and said inside wall, and said grading means having a plurality of further grading positions corresponding to rotational locations of said grading means where marine animals of progressively reducing size range can be directed through said landing and out of said receptacle.

3. The system according to claim 1 or 2 wherein said receptacle is supported on a carriage providing the system with at least a degree of motion.

4. The system according to claim 3 wherein said carriage is arranged to facilitate linear and/or rotational motion of said receptacle.

5. The system according to any one of claims 1-4 wherein each panel is demountably coupled at an axial iner edge to said grading means to allow said panels t be tilted or lifted about a corresponding axial outer edge when in this corresponding grading position to further direct marine animals to pass through said landing.

6. The system according to any one of claims 1-5 further including a vessel for holding a further volume of water and in which said receptacle is disposed, and wherein said receptacle is in fluid communication with said vessel whereby water can flow between said vessel and receptacle without a transfer of the marine animals.

7. The system according to claim 6 wherein said grading means rotates relative to said receptacle.

8. The system according to claim 7 wherein said receptacle is provided with a single landing and a set of grading positions are characterised by a length of the outer peripheral edge of said panels being rotated to a location adjacent said landing.

9. The system according to claim 6 wherein said grading means and receptacle rotate together.

10. The system according to claim 9 wherein the receptacle is provided with a plurality of landings, one for each panel of said grading means where the landing is adjacent a length of the outer peripheral edge of each panel, with the receptacle further including a plurality of gates for selectively opening and closing said landing.
